(19) United States
(12) Patent Application Publication
(10) Pub. No.: US 2026/0022050 A1
(43) Pub. Date: Jan. 22, 2026

(54) HOT JOINING PROCESS FOR PRODUCING COMPLEX LIGHT-WEIGHT STRUCTURES

(71) Applicant: Schott AG, Mainz (DE)

(72) Inventors: Ralf Jedamzik, Greisheim (DE); Clemens Kunisch, Armsheim (DE); Hauke Esemann, Alzey (DE); Peter Daniel Hohmann, Rüsselsheim (DE); Martin Schäfer, Mainz-Kostheim (DE); Jürgen Vogt, Oberheimbach (DE); Rudolf Müller, Bingen (DE)

(73) Assignee: Schott AG, Mainz (DE)

(21) Appl. No.: 18/996,372

(22) PCT Filed: Jul. 19, 2023
(86) PCT No.: PCT/EP2023/069993

§ 371 Date: Jan. 17, 2025

(30) Foreign Application Priority Data
Jul. 19, 2022 (DE) 10 2022 118 025.5
Jul. 19, 2023 (WO) PCTEP2023069993

(51) Int. Cl. C03B 23/20; C03B 23/00

(52) U.S. Cl. CPC C03B 23/20; C03B 23/0013

(57) ABSTRACT

The invention relates to a method for producing a glass-ceramic composite object, and a glass-ceramic composite object produced from at least two starting elements. In the method, respective surfaces of at least two starting elements consisting of the precursor glass of the glass-ceramic material are pressed flat and directly against one another with the application of pressure, and at a temperature at which the ceramisation of the glass-ceramic material takes place they are joined so as to create a monolithic bond between the at least two starting elements.

### CROSS-REFERENCE TO RELATED APPLICATIONS

This application is a national stage entry under 35 U.S.C. § 371 of International Patent Application No. PCT/EP2023/069993 entitled “HOT JOINING PROCESS FOR PRODUCING COMPLEX LIGHT-WEIGHT STRUCTURES” and filed on Jul. 19, 2023, which is incorporated in its entirety herein by reference. International Patent Application No. PCT/EP2023/069993 claims priority to German Patent Application No. 10 2022 118 025.5 filed on Jul. 19, 2022, which is incorporated in its entirety herein by reference.

### BACKGROUND OF THE INVENTION

### 1. Technical Field of the Invention

The present invention relates to a process for producing a glass-ceramic composite body, and to a glass-ceramic composite body produced from at least two starting elements. In the process, one surface of each of the at least two starting elements consisting of the green glass of the glass-ceramic are pressed two-dimensionally and directly against one another under the action of pressure and are bonded at a temperature at which ceramization of the glass-ceramic takes place, so as to create a monolithic bond between the at least two starting elements.

### 2. Description of the Related Art

LAS glass-ceramics are produced in a multistage process. After the raw materials have melted and been cast to a shape, the LAS green glass is first cooled down to room temperature. Thereafter, the green glass is converted in a subsequent ceramization process to the LAS glass-ceramic.

There have already been attempts to bond parts of glass-ceramics to form composite components. However, the methods used to date for this purpose have considerable drawbacks, especially for precision components intended for space applications. For example, bonding materials such as adhesives and solders are used in the joining of glass-ceramic components, and these have poorer properties than the glass-ceramic, in particular in that they lack or have poorer zero expansion, such that, as the composite component is heated or cooled, stresses arise in the composite and impair the stability of the composite component.

Further traditional bonding techniques, such as contact bonding or LTB (low-temperature bonding) methods, place high demands on the quality of the surfaces to be bonded; a small gap size of a few μm, i.e. less than 10 μm, is required, and hence complex polishing of the surfaces to be bonded. Moreover, such techniques are not applicable to large components, for example components having a diameter and/or an edge length of 3 or 4 m.

DE102005036224 B4 describes a method of joining green glasses of glass-ceramics, in which very high heating rates of >5 K/min are employed, and ceramization and joining are effected at a significantly higher temperature.

### SUMMARY OF THE INVENTION

It was thus the object of the invention to provide an improved process for producing composite components from zero-expansion glass-ceramics, with which composite components having high CTE homogeneity and high mechanical stability can be produced. In particular, the process is also to enable the producing of large composite components having a diameter or edge length of, for example, more than 0.5 m or 1.0 m.

The present invention has various aspects:

In particular, a process for producing a glass-ceramic composite body having a coefficient of thermal expansion CTE in the range from 0 to 50° C., for example, of not more than 0±0.1×10⁻⁶/K is provided, comprising the steps of
providing at least two starting elements consisting of the green glass of the glass-ceramic,
arranging the at least two starting elements and contacting the surfaces of the starting elements to be bonded,
two-dimensionally pressing the surfaces of the at least two starting elements to be bonded to one another under the action of pressure (P),
optionally, controlled geometric deformation of at least one starting element at a temperature between T_{g} and T_{g}+Tₛ by sagging into a target shape,
creating a monolithic bond between the at least two starting elements by heating, under the action of pressure (P), the starting elements pressed to one another at a temperature T_{K} at which ceramization of the green glass to the glass-ceramic takes place.

According to the invention, the term “pressure” means a force acting on a surface, especially a force acting on the surfaces or bonding sites to be bonded. According to the invention, such a force can (a) create a pressure on the bonding sites by virtue of the intrinsic weight of an upper starting element or (b) create a pressure on the bonding sites by virtue of one or more added weights lying on an upper starting element or (c) bring about a tensile force on the starting elements by application of vacuum and hence create a pressure on bonding sites or (d) be a combination of one or more of the aforementioned variants (a) to (c).

In a further aspect of the invention, a monolithic composite body is provided, which has a coefficient of thermal expansion CTE in the range from 0 to 50° C., for example, of not more than 0±0.1×10⁻⁶/K, and which is producible by a process as claimed in any of claims 1 to 8.

At least two starting elements, preferably all starting elements, consist of the green glass of a zero-expansion glass-ceramic, meaning that the glass-ceramic formed from the green glass by ceramization has an average coefficient of thermal expansion CTE or a in the range from 0 to 50° C., for example, of not more than 0±0.1×10⁻⁶/K. Some advantageous variants even have an average CTE in the range from 0 to 50° C., for example, of not more than 0±0.05×10⁻⁶/K or of not more than 0±0.02×10⁻⁶/K. For particular applications, it may be advantageous when the average CTE in a larger, smaller or different temperature range, for example in the range from 18 to 25° C., in the range from −30° C. to +70° C., in the range from −40° C. to +80° C., is not more than 0±0.1×10⁶/K or not more than 0±0.05×10⁻⁶/K or not more than 0±0.02×10⁶/K, i.e. there is a zero expansion. The coefficient of thermal expansion is preferably optimized in the region of the use temperature.

Preferably at least two, more preferably all starting elements have the same CTE. In one variant, preferably more than 50%, more preferably more than 90% and in particular variants of the invention all of the starting elements come from one batch. What is meant by a batch in this connection is that they come from the same casting and, in one variant of the invention, preferably have been cut from the same green glass block. As a result, in the resulting composite component, it is possible to achieve a CTE (coefficient of thermal expansion) homogeneity over a size of 4 m of up to 10 ppb/K peak-to-valley.

In one aspect of the invention, at least two starting elements, preferably all starting elements, consist of the green glass of a glass-ceramic that has high CTE homogeneity. The CTE homogeneity value (“total spatial variation of CTE”) means the peak-to-valley value, i.e. the difference between the samples taken from the respective highest and respective lowest CTE values.

In one aspect of the invention, at least two starting elements, preferably all starting elements, consist of the green glass of a glass-ceramic that has thermal hysteresis of <0.1 ppm at least in the temperature range from 10° C. to 35° C. Thus, at any temperature within the temperature interval from 10° C. to 35° C., the glass-ceramic, once it has been subjected to a change in temperature, shows an isothermal change in length of less than 0.1 ppm at a subsequent constant temperature. In advantageous executions, this freedom from hysteresis exists at least in a temperature range from 5 to 35° C., preferably at least in the temperature range from 5 to 45° C., preferably at least in the temperature range from >0° C. to 45° C., preferably at least in the temperature range from −5° C. to 50° C. More preferably, the temperature range of the freedom from hysteresis is even broader. Preferred use temperatures are in the range of −60 to 100° C., more preferably from −40° C. to +80° C. Particular variants of the present invention relate to glass-ceramics and precision components for use temperatures TA, for example, in the range of 5° C. to 20° C. or TA of 22° C., 40° C., 60° C., 80° C. and 100° C., which are preferably hysteresis-free at these temperatures too.

For instance, the starting elements may be manufactured a lithium aluminum silicate glass (LAS glass) which, like the LAS glass-ceramic that originates from such an LAS glass, has the following composition (in % by weight based on oxide):

| | |
|---|---|
| SiO₂ | 50-70 |
| Al₂O₃ | 15-32 |
| P₂O₅ | 3-12 |
| Li₂O | 2-5 |
| Na₂O | 0-2 |
| K₂O | 0-2 |
| MgO | 0-2 |
| CaO | 0-4 |
| BaO | 0-5 |
| SrO | 0-2 |
| ZnO | 0-4 |
| TiO₂ | 1-5 |
| ZrO₂ | 0-5 |

The glass or glass-ceramic preferably contains a proportion of SiO₂ of 50% to 70% by weight. The proportion of SiO₂ is more preferably not more than 62% by weight, further preferably not more than 60% by weight. More preferably, the proportion of SiO₂ is at least 52% by weight, further preferably at least 54% by weight.

The proportion of Al₂O₃ is preferably from 17% to 32% by weight. More preferably, the glass or the glass-ceramic contains at least 20% by weight, further preferably at least 22% by weight, of Al₂O₃. The proportion of Al₂O₃ is more preferably not more than 30% by weight, more preferably not more than 28% by weight.

The phosphate content P₂O₅ of the glass or of the glass-ceramic is preferably 3% to 12% by weight. More preferably, the glass or the glass-ceramic contains at least 4% by weight, further preferably at least 5% by weight, of P₂O₅. The proportion of P₂O₅ is preferably limited to not more than 10% by weight, more preferably to not more than 8% by weight.

The glass or the glass-ceramic preferably also contains TiO₂ in a proportion of 1% to 5% by weight; there is preferably at least 1.5% by weight of TiO₂. However, the proportion is preferably limited to not more than 4% by weight, more preferably to not more than 3% by weight.

The glass or the glass-ceramic may also contain ZrO₂ in a proportion of not more than 5% by weight, preferably not more than 4% by weight. Preferably, ZrO₂ is present in a proportion of at least 0.5% by weight, more preferably at least 1% by weight.

In addition, the glass or the glass-ceramic may contain alkali metal oxides, such as Li₂O, Na₂O and K₂O. Li₂O is preferably present in a proportion of at least 2% by weight, preferably at least 3% by weight. The proportion of Li₂O is limited to preferably not more than 5% by weight, more preferably not more than 4% by weight. Na₂O and K₂O are optionally present in the glass or in the glass-ceramic. The proportion of Na₂O and/or K₂O may in each case, and independently of one another, be not more than 2% by weight, preferably not more than 1% by weight, most preferably not more than 0.5% by weight. Na₂O and K₂O may each be present in the glass-ceramic, and independently of one another, in a proportion of at least 0.01% by weight, preferably at least 0.02% by weight, more preferably at least 0.05% by weight.

The glass or the glass-ceramic may also contain alkaline earth metal oxides, such as MgO, CaO, BaO and/or SrO, and further divalent metals such as ZnO. The proportion of CaO is preferably not more than 4% by weight, further preferably not more than 3% by weight, more preferably not more than 2% by weight. The glass or the glass-ceramic preferably contains at least 0.1% by weight, more preferably at least 0.5% by weight, of CaO. MgO may be present in the glass or in the glass-ceramic in a proportion of not more than 2% by weight, preferably not more than 1.5% by weight, and/or preferably at least 0.1% by weight. The glass or the glass-ceramic may contain BaO in a proportion of less than 5% by weight, preferably not more than 4% by weight, and/or preferably at least 0.1% by weight. In individual embodiments, the glass or the glass-ceramic is BaO-free. The glass or the glass-ceramic may contain SrO in a proportion of not more than 2% by weight, and/or preferably at least 0.1% by weight. In individual embodiments, the glass and the glass-ceramic are SrO-free. A further metal oxide present in the glass or in the glass-ceramic is preferably ZnO in a proportion of preferably at least 1% by weight, more preferably at least 1.5% by weight. The proportion of ZnO is limited to not more than 4% by weight, preferably not more than 3% by weight.

The glass or the glass-ceramic may further comprise one or more customary refining agents, such as As₂O₃, Sb₂O₃, SnO, SO₄²⁻, F⁻, Cl⁻, Br⁻, or a mixture thereof, in a proportion of not more than 1% by weight.

In this system, transparent glass-ceramics having low coefficients of thermal expansion are known, and commercial products such as Zerodur®, Zerodur® M (both SCHOTT AG) and Clearceram® (Ohara Inc.) may be mentioned by way of example. Such glass-ceramics having low thermal expansion are described, for example, in U.S. Pat. Nos. 4,851,372, 5,591,682, EP 587979 A, U.S. Pat. Nos. 7,226,881, 7,645,714, DE 102004008824 A, DE 102018111144 A, DE 102022105929 A, DE 102022105930 A.

These glass-ceramics typically contain, as the main crystal phase, about 50% to 80% high-quartz-containing solid solutions that are also called β-eucryptite solid solutions. This crystallization product is a metastable phase which, depending on the crystallization conditions, changes its composition and/or structure or is transformed to another crystal phase. The high-quartz-containing solid solutions have very low thermal expansion, or even falling thermal expansion with rising temperature.

The starting elements may have different functions in the resultant composite body. In particular, it is possible to distinguish between functional elements and reinforcing elements.

A reinforcing element may be regarded here as a lightweight structure component which is suitable and intended to be bonded to a functional element, for instance a mirror substrate or a reverse side of a roof or of a cover panel, and to bear and to stabilize the latter after bonding, in order to be able to reduce the risk of deformation of the functional element, such as a mirror in particular, during operation.

A reinforcing element has at least one cavity, but preferably many cavities. These cavities ensure a reduction in weight of the reinforcing element. The thinner the walls of the bars of the reinforcing element and/or the larger the cavities thereof, the lower the weight of the reinforcing element. In one embodiment, the averaged density of the reinforcing element may be less than 0.3 g/cm³ or even less than 0.25 g/cm³. The averaged density is found from the ratio of the weight of the reinforcing element to the volume of the reinforcing element defined by the external measurements. The proportion by volume of the cavities of the reinforcing element may be at least 85% by volume.

The cavities may, for example, be circular, oval, angular, triangular, quadrangular, hexagonal, octagonal, or have a different polygonal shape. The cavities may have the same shape and/or dimension at least in one or more inner regions of the reinforcing element. However, combinations of different shapes are also possible, for example a structure composed of honeycomb and circular cavities. The reinforcing element may also have a structure composed of cavities having equal and nonequal dimensions. An example of a conceivable structure is one composed of circular cavities having different diameters, such that smaller cavities are disposed between larger cavities, in order to achieve a maximum reduction in weight with constant optimal stabilization. However, the reinforcing element may also have a regular structure of the cavities, or repeatedly arranged cavities.

In one embodiment, it is the case that the reinforcing elements has at least two surfaces arranged opposite one another, where at least one, preferably both, may be permeated by cavities.

At least one first and optionally also one second functional element are provided for bonding to the reinforcing element.

A functional element, in one embodiment of the invention, is in sheet or disk form. The functional element may, for example, be a mirror substrate or backing or a reverse side of a roof or a reverse side of a cover panel.

The second functional element may preferably take the form of a reverse side of a roof or a reverse side of a cover sheet, for example for a further increase in stiffness. In this case, the second functional element and/or the outer wall of the reinforcing element may have recesses, for example in the form of holes, especially vent holes. Such vent holes may serve for physical exchange of the cavities of the reinforcing element with the environment. Pressure compensation should be mentioned in this context, since there may be gases in the cavities that can undergo changes in volume as a result of thermal or temperature changes, and such changes in volume could possibly cause deformations in the first functional element disposed thereon. Such a risk is distinctly reduced by recesses in the second functional element. In addition, in one variant of the process of the invention, it is possible by means of such openings, upon execution of the process of the invention, to apply a vacuum and hence to press the bonding faces of the first functional element and/or of the second functional element against the bonding faces of the reinforcing element by means of subatmospheric pressure.

The first and/or the second functional element may be intended for bonding to one surface each of the reinforcing element, such that the first functional element is disposed on or above one surface of the reinforcing element and the second functional element could be disposed on or above the oppositely disposed surface of the reinforcing element. In this way, it is possible to achieve a sandwich structure in which the reinforcing element may be disposed between the first and second functional elements, in order to obtain a particularly stable and robust composite body.

The functional elements may partly or fully cover the surface of the reinforcing element. However, the surface of the first and especially also second functional element is preferably designed to be complementary to the surface of the reinforcing element, such that the surface(s) of the reinforcing element are fully covered by the first and/or second functional element. In a further variant of the invention, the first and/or the second functional element may have a greater diameter than the reinforcing element.

In one variant of the invention, it is preferable that reinforcing elements at least at the edge of the composite component have an elevated cross section or thickness by at least 20%, preferably at least 50%, in particular embodiments 100% or more, in order to assure better stability during the joining process and any sagging process. Such thicker reinforcing elements may be rounded off in the subsequent processing operation to reduce the total weight of the composite components.

In one aspect of the invention, at least one starting element has a diameter and/or an edge length of at least 0.5 m, preferably at least 1 m, further preferably at least 2 m and more preferably at least 3 m.

For the process of the invention, starting elements composed of a green glass of a glass-ceramic are provided. The green glass is typically in the form of a cast block or ingot. The starting elements are worked in the required dimensions from such a block or ingot by, for example, cutting and/or CNC processing and/or waterjet cutting.

Lightweight processing is optionally possible in the case of one or more starting elements. In particular, it is possible for this purpose to create cavities or recesses in a starting element, where a distinction may be made here between blind holes and passage openings or holes. Such cavities may likewise be created by processing by means of a CNC machine or another material-removing or material-penetrating technique. In one variant of the invention, in particular, passage openings are created, preferably by waterjet cutting. Waterjet cutting in particular makes it possible to produce cavities that have particularly low wall thicknesses of the bars or inner walls, for example not more than 5 mm, preferably not more than 2.5 mm, and/or at least 0.5 mm, more preferably at least 1 mm. In particular variants, the bars in the case of relatively small mirrors of diameter less than 0.5 m may also only have a bar width of at least 0.2 mm and/or at most 0.5 mm.

In one embodiment of the process of the invention, the surfaces of the starting elements to be bonded need not be highly polished. The surfaces of the starting elements to be fused may be processed, for example, by a lapping method which is performed, for example, by a CNC machine. This achieves a flatness of not more than 500 μm, more preferably not more than 250 μm, and at least 100 μm. Such flatness may be achieved on surfaces of components or elements having a diameter or an edge length of, for example, less than 50 cm, less than 1 m, less than 2 m, less than 3 m or less than 5 m.

In this embodiment, the surfaces of the starting elements that are to be bonded also preferably have a roughness of not more than 0.1 μm Ra, more preferably 0.06 μm Ra.

In a further variant of the invention, surfaces having relatively high flatness and relatively low roughness are preferred, and at least one of the surfaces of the starting elements is subjected to a fine grinding process and/or polishing process in order to adjust the flatness to a value of less than 100 μm, preferably less than 50 μm, further preferably less than 20 μm.

In this embodiment, the surfaces of the starting elements that are to be bonded also preferably have a roughness of not more than 0.03 μm Ra, more preferably 0.02 μm Ra.

According to the invention, in general, no special cleaning of the starting elements is required after lapping, grinding and/or polishing; cleaning with solvents such as water or isopropanol is sufficient. In one variant of the invention, the surface can be deionized, for example, by blowing with ionized air, in order to remove any charges present on the surfaces.

The prepared starting elements are arranged relative to the green glass structure in a kiln so as to result in the desired composite component after joining and optionally sagging. If appropriate, additional weights and/or a device for applying vacuum are positioned on the green glass structure.

Subsequently, the temperature in the kiln is increased to the desired temperature T_{F} at a heating rate of not more than 10 K/h, preferably not more than 5 K/h, and/or at least 1 K/h, more preferably at least 3 K/h.

T_{F} is at or above the transition temperature T_{g} of the green glass of the glass-ceramic, i.e. the temperature at which the green glass has a viscosity of about 1013 dPas, and at a temperature T_{K} within which crystal nucleation and crystal growth occur in the glass-ceramic. However, T_{F} is below a temperature at which the green glass of the glass-ceramic has a viscosity of 109 dPas. The temperature T_{K} is maintained until the ceramization of the glass-ceramic to the desired degree is complete. The temperature T_{K} and the duration of the hold time at T_{K} are dependent on the composition of the glass-ceramic and may be suitably selected by a skilled person.

As the green glass of the glass-ceramic is heated and held at a constant temperature, firstly crystal nucleation and then growth of the crystal nuclei take place in the glass. This crystal growth is the reason why a monolithic bond can form between two bonding faces, preferably under the action of pressure (P). The existing but still low viscosity of the material at the temperature T_{K} ensures that the material can adapt to any unevenness under the action of pressure (P) while the bonding reaction is taking place via the ceramization and the crystal growth.

Optionally, during the joining, one or more additional weights and/or one or more devices may be disposed against or on the green glass structure on application of a vacuum. In order to assist the joining process, it may be advantageous for the surfaces that are to be joined to be pressed together by means of a pressure P. Such a compression force should always act essentially at right angles to the bonding faces. Even the intrinsic weight of a further starting element lying on a starting element can exert a sufficient compressive force on the surfaces of the starting elements that are to be bonded.

In one embodiment, in addition, at least one additional weight is placed on the uppermost starting element, in order thus to amplify the compressive force on the surfaces to be bonded during joining and any sagging. This is advantageous especially in places where the tensile force of the vacuum cannot act correctly, if at all.

In a further embodiment, in order to assist joining and optionally sagging as shown schematically in FIG. 1b, a vacuum is applied to the green glass structure. Preferably, for this purpose, the underside or bottom of the green glass structure and the contact face of the glass structure have at least one, preferably multiple recesses, by means of which a vacuum can be applied in the interior of the green glass structure and hence a tensile force (P) can act on the bonding sites of the green glass structure. Preferably, the green glass structure is first heated to or above the temperature T_{g} and the vacuum is applied to the green glass structure only when the green glass begins to soften and hence a vacuum-tight bond between the starting elements can be created. According to the invention, the aim is a full-area bond of the bonding sites of the starting elements. Full-area bonding is particularly critical at the outsides of the composite component. In one variant of the invention, therefore, in addition to the applying of a vacuum, weights can be placed at least above the outsides of the green glass elements, in order to assist full-area bonding at the outsides of the composite component.

The directed tensile or compressive force P which is optionally created in this way by weights on top and/or the applying of vacuum is thus higher than the pressure caused by the intrinsic weight of the functional element and is at least 0.1 MPa, or at least 0.02 MPa. By virtue of this pressure P within the above-specified temperature range, it is possible to precisely establish deformation of a functional element 2, 3 of preferably less than 0.6 mm, for example between 0.1 mm and 0.4 mm. This creates characteristic curvatures 15 (see FIG. 7) at the surface 4 of the functional element 2, 3, which form in particular between the inner walls 13 and/or between the inner walls 13 and at least one outer wall 14 by virtue of the pressure P and softening of the vitreous material that takes place in the aforementioned temperature range.

The process of the invention may also comprise the process step of sagging the green glass structure of starting elements, i.e. the step of controlled geometric deformation of at least one starting element by sagging into a target shape.

While, in above-described embodiments without the step of sagging, the shape of the starting elements is transformed essentially unchanged to the composite component during the bonding and ceramizing, the process step of sagging brings about a controlled geometric change in at least one starting element, or else in the green glass structure overall. For example, a flat plate or green glass structure may be converted to a concave- or convex-curved shape. The extent of sagging can be determined by what is called the stroke or the arrow height. The arrow height here means the distance measured between the plane defined by an annular cutter placed onto the mirror surface and the height of the mirror surface in the middle of the annular cutter. According to the invention, a green glass body is lowered only to a small extent, especially by a factor of mirror diameter to the arrow height of at least 0.01%, more preferably of at least 0.02%, and/or preferably of not more than 3%, more preferably not more than 2%, in particular variants of the invention up to not more than 7%. This corresponds, for example, to a stroke or an arrow height of 0.1 to 15 mm in the case of a mirror having a diameter of 400 to 500 mm.

However, the lowering preferably essentially does not result in any significant change in the geometry of reinforcing elements.

The process step of sagging takes place essentially prior to the ceramization of the glass-ceramic. In this variant of the invention, therefore, for the process step of sagging, the green glass structure is preferably heated at first only to a temperature of T_{g} to T_{g}+Tₛ, where it is preferably the case that T_{g}+Tₛ<T_{K}, and kept there until the green glass structure has sagged into the desired final shape. The temperature T_{g}+Tₛ is a temperature at which there is essentially still no crystal nucleation and/or crystal growth. It is further preferable to control the heating of the green glass structure such that a sufficiently large process window is available for the sagging, in that the green glass structure is preferably heated relatively rapidly, for example at a heating rate of not more than 10 K/h, or not more than 5 K/h. The proportion of the crystal phase during the sagging of the green glass structure should be not more than 30%, or not more than 20% by volume, or not more than 10% by volume or not more than 1% by volume.

Just like the process step of joining, the process step of sagging can be assisted by a pressure P exerted on the starting element to be sagged. The pressure P can be increased by placing on one or more weights and/or applying vacuum to the starting element to be sagged. Such a vacuum is preferably applied only on attainment of the sagging temperature and preferably lifted again after the sagging process has ended, in order that there is no further deformation of the structure.

On conclusion of the sagging, the sagged green glass structure is preferably heated further as described above to the ceramization temperature T_{K}, and the green glass structure is joined and ceramized to give the composite component in the same kiln process.

In one variant of the present invention, the composite component produced by the process of the invention has high CTE homogeneity. The CTE homogeneity value (“total spatial variation of CTE”) means the peak-to-valley value, i.e. the difference between the respectively highest and the respectively lowest CTE value of the individual components.

The composite component of the invention has form-fitting bonding of the ceramized starting elements up to the edge. A measure used for form-fitting bonding may be the loss of internal transmittance of the composite body compared to a body of the bulk ceramic of the same thickness. The loss of internal transmittance may thus be less than 0.32.

The composite component of the invention has contact over virtually all contact surfaces, especially at least 90%, preferably at least 95% of the contact surface.

The measured stresses overall and hence also in particular in the bonding regions of the elements of the composite body are preferably not more than 12 nm/cm, more preferably not more than 10 nm/cm.

The composite body of the invention, in one variant of the invention, has a low averaged density. In one embodiment, without restriction to the example shown, the averaged density of the reinforcing element is less than 0.3 g/cm³ or even less than 0.25 g/cm³. The averaged density is found from the ratio of the weight of the reinforcing element to the volume of the reinforcing element defined by the external measurements. It is preferably the case for the composite body, which has a somewhat higher density because of the bulk functional elements, that the averaged density of the composite body is still lower than 0.5 g/cm³. The proportion by volume of the cavities is at least 80% by volume.

The composite components produced by the process of the invention are preferably used as precision components selected from the group consisting of astronomic mirrors and mirror substrates for segmented or monolithic astronomic telescopes; lightweight or ultralightweight mirror substrates, for example for space-based telescopes; high-precision structure components for distance measurement, for example in space; optics for observation of the Earth; precision components, such as standards for precision metrology, precision scales, reference plates in interferometers; mechanical precision parts, for example for ring laser gyroscopes, spiral springs for the watch industry; mirrors and prisms in LCD lithography; mask holders, wafer stages, reference plates, reference frames and grating plates in microlithography and in EUV (extreme UV) microlithography in which reflective optics are used; mirrors and/or photomask substrates or reticle mask blanks or mask blanks in EUV microlithography; and components for metrology or spectroscopy.

### BRIEF DESCRIPTION OF THE DRAWINGS

The figures show:

FIGS. 1a-1c schematic diagrams of first and second functional elements having a reinforcing element (FIG. 1a), the process of the invention with a green glass structure (FIG. 1.b), and a composite body (FIG. 1c) of the invention in one variant of the invention.

FIG. 2 a process for producing a glass-ceramic composite body with the aid of an additional weight having a base area similar to the base area of the reinforcing element.

FIG. 3 a process for producing a glass-ceramic composite body with the aid of an additional weight having a base area similar to the base area of the reinforcing element with a thickened outer wall.

FIG. 4 a process for producing a glass-ceramic composite body with the aid of an additional weight having an increased base area compared to the base area of the reinforcing element with a thickened outer wall.

FIG. 5 a process for producing a glass-ceramic composite body with the aid of several partial additional weights above a reinforcing element with a thickened outer wall.

FIG. 6 an illustrative arrangement of partial additional weights.

FIG. 7 a schematic side view of a ceramized composite body.

FIGS. 8a-8b a schematic perspective diagram of a ceramized composite body in one variant (FIG. 8a) and a photograph of a ceramized composite body in a further variant (FIG. 8b).

FIG. 9. a scanning electron micrograph of the bonding region of a functional element to the reinforcing element;

FIG. 10 a schematic cross section of the bonding region of the reinforcing element to the functional element;

FIG. 11a a stress birefringence measurement profile of the composite body;

FIG. 11b a stress birefringence measurement diagram of the composite body;

FIG. 12 a stress birefringence measurement diagram of the bonding region of the reinforcing element to the functional element;

FIG. 13 a schematic diagram of the process of the invention comprising the optional step of sagging.

FIG. 14 a schematic diagram of a sagged composite body (bottom) compared to an unsagged composite body (top).

### DETAILED DESCRIPTION OF THE INVENTION

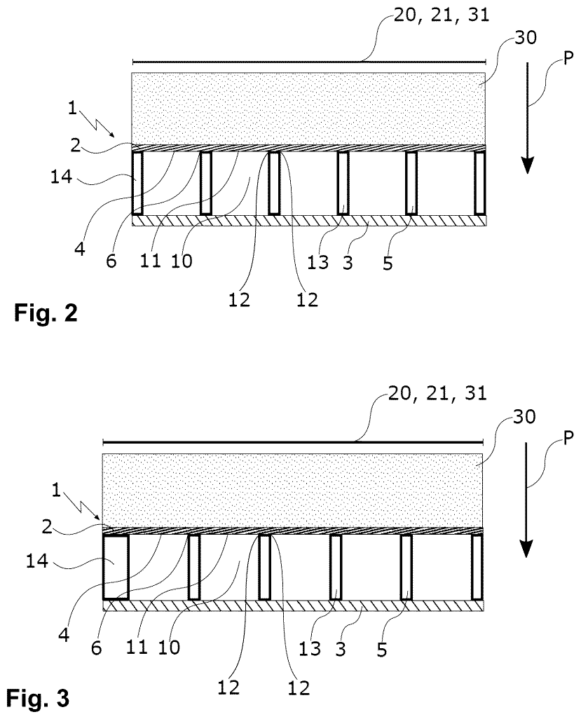

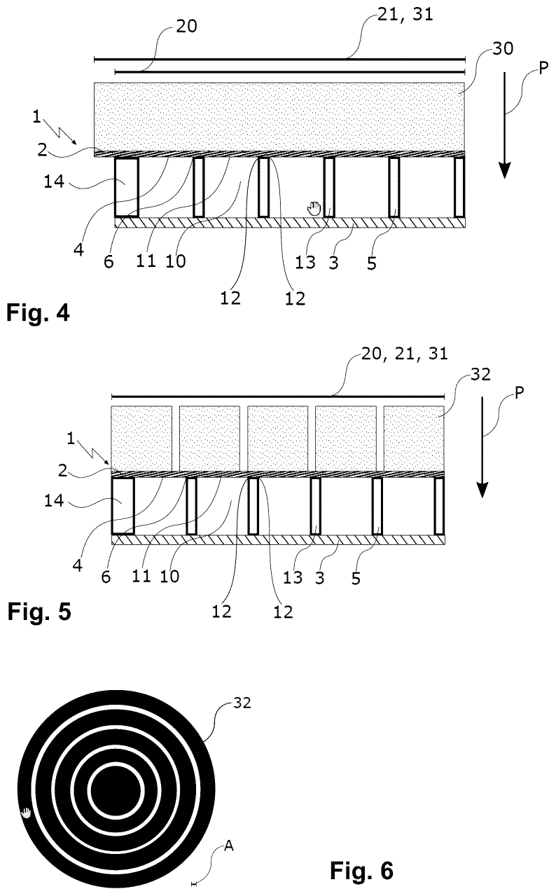

FIGS. 2-6 show a process for producing a glass-ceramic composite body 1. It is possible here for a surface 4 of a first functional element 2 to be arranged, preferably in a flush arrangement, on a surface 6 of a reinforcing element 5. Ideally, the reinforcing element 5 has at least one, preferably more than one of the following features: at least one, preferably a multitude of cavities 10, openings 11 that penetrate the surface 6 or are open to the outside, inner walls 13, one or more outer walls 14, sides of the openings 12, a base area 20 of the reinforcing element 5.

The aim of the process is the ceramization and monolithic bonding of the ceramizable, vitreous elements provided and manufactured from green glass, especially the first functional element 2 and the reinforcing element 5. It is optionally possible to bond a second functional element 3 to the reinforcing element 5. FIGS. 2 to 6 also show an illustrative process setup. It is possible, as shown in these examples, to provide a reinforcing element 5 which is bonded in the course of the process to a first functional element 2 and/or a wide functional element 3, where the first functional element 3 preferably functions as mirror substrate and the second functional element 3 preferably functions as reverse side of a cover panel.

The reinforcing element 5 is generally disposed between the first functional element 2 and second functional element 3. The first functional element 2, in one variant of the invention, is disposed between an additional weight 30 and the reinforcing element 5, where the first functional element 2 is arranged in direct contact with the reinforcing element 5, and especially lies thereon. The surface 4 of the functional element 2 lies on the surface 6 of the reinforcing element here such that it makes contact with the openings 11 and hence also the cavities 10. The inner walls 13 are preferably arranged between the cavities 10, where the cavities ideally extend through the reinforcing element such that the cavities extend from one surface 6 to a surface opposite the surface 6, and especially break through at least one, preferably both surfaces. This means that the first functional element 2 is disposed on the inner walls 13 and/or on the outer walls 14 of the reinforcing element 5.

After the additional weight 30, the reinforcing element 5 and the first functional element 2 and/or second functional element 3 have been arranged, as shown in FIGS. 2 to 5, the ceramization operation can commence.

By virtue of the arrangement of the elements and of the additional weight, a directed pressure P acts by virtue of the weight of the additional weight on at least the first functional element 2 or second functional element 3, and especially also on the reinforcing element 5. The directed pressure P may then act, for example, at right angles to the surface 4 of an element 2, 3, 5, especially the first functional element 2 or second functional element 3, or parallel to a surface normal of the surface 4 of the first functional element 2 and/or second functional element 3. It is also possible here that this surface is curved.

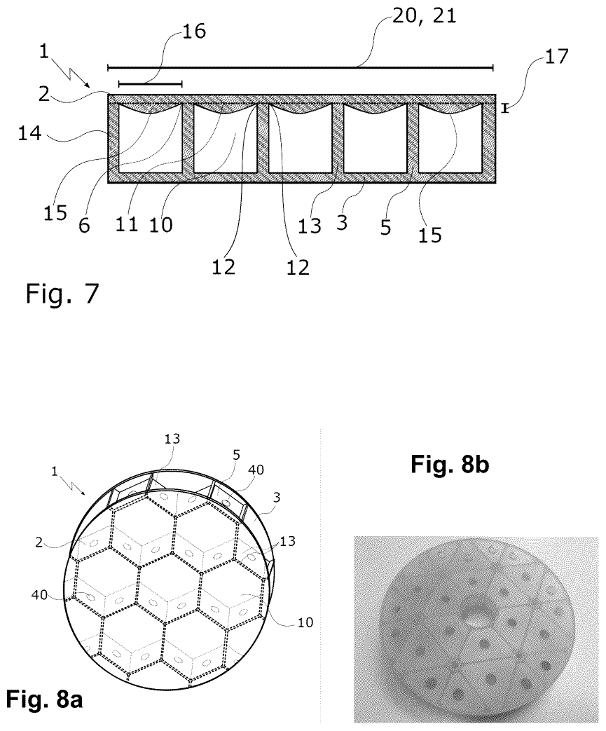

The directed pressure P is higher than the pressure caused by the intrinsic weight of the functional element, and is preferably between 0.01 MPa and 0.1 MPa, more preferably about 0.02 MPa. By virtue of this pressure P within the above-specified temperature range, it is possible to precisely establish deformation of a functional element 2, 3 of preferably less than 0.6 mm, for example between 0.1 mm and 0.4 mm. This creates characteristic curvatures 15 (see FIG. 7) at the surface 4 of the functional element 2, 3, which in particular between the inner walls 13 and/or between the inner walls 13 and at least one outer wall 14 by virtue of the pressure P and softening of the vitreous material that takes place in the aforementioned temperature range.

FIG. 2 shows the process setup with the additional weight 30 disposed above or atop a functional element 2, 3. This additional element 30 exerts directed pressure that preferably acts uniformly on the functional element 2, 3. The functional element 2, 3 is disposed atop the reinforcing element, or on the inner walls 13 and outer walls 14. In the side view, the inner walls 13 and outer walls 14 are formed separately from one another by means of the continuous cavities 10, i.e. the cavities 10 lie between the inner walls 13 and outer walls 14. The outer walls 14, or a thickness of the outer walls 14, have an at least similar thickness to the inner walls 13, preferably even the same thickness.

A base area 20 of the reinforcing element 5 may correspond to a base area 21 of at least one functional element 2, 3. It is also possible here that a base area 31 of the additional weight 30 corresponds to the base area 20, 21 of the reinforcing element and especially of a functional element 2, 3. As a result, the effective pressure is distributed virtually uniformly.

Since stability in edge regions tends to decrease if anything, it is possible, as in FIGS. 2 to 5, to make the outer wall 14 of the reinforcing element 5 thicker than the inner walls 13; for example, the thickness of the outer walls 14 may be twice or three times the thickness of the inner walls 13. In order to cause the load or the pressure P to act more uniformly on the outer walls as well, the base area 31 of the additional weight 30 and/or the base area 21 of a functional element 2, 3 as shown in FIG. 3 may be greater than the base area 20 of the reinforcing element 5. This relates more particularly to a length, width and/or a diameter of the base areas 20, 21, 31.

FIGS. 5 and 13 show a similar setup to FIGS. 2 to 3, except that, rather than a single additional weight 30, there are several partial additional weights 32 arranged above or atop the functional element 2, 3. In this way, it is possible to distribute the pressure P more precisely over the regions where a monolithic bond of the functional element 2, 3 with the reinforcing element is created. For example, these may be exactly the regions on which a functional element 2, 3 lies atop an inner wall 13 and/or outer wall 14 of the reinforcing element. Regions above cavities 10 or openings 11 are under lower stress as a result. FIG. 6 shows, by way of example, one configuration form of partial additional weights 32. The partial additional weights 32 may accordingly be in the form of a ring and especially have different diameters, such that the partial additional weights 32 may be arranged one inside another, or partial additional weights 32 having a small diameter may be arranged within partial additional weights 32 having greater diameter. A defined distance A is preferably allowed between the partial additional weights.

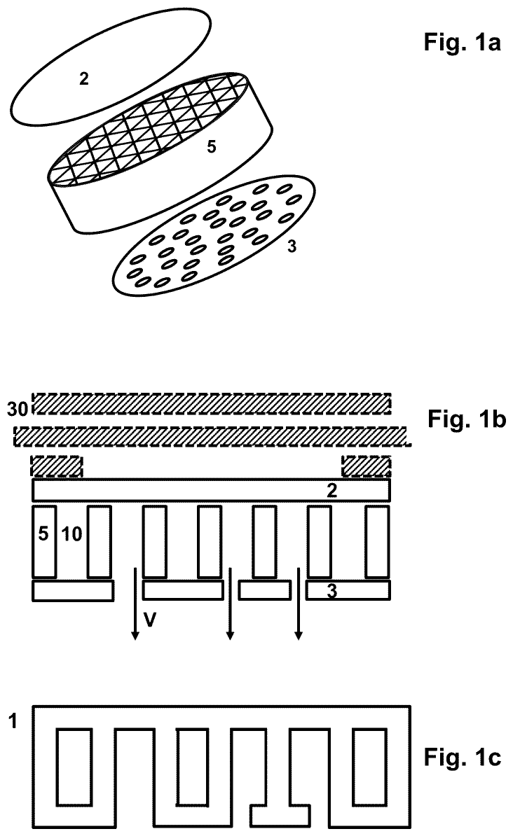

FIGS. 7 and 8 show a glass-ceramic composite body 1 created in FIGS. 2 to 6 in a schematic diagram. FIG. 7 shows, in a diagram similar to FIGS. 1 to 5, how the composite body is constructed. A dotted line indicates where the interface of the functional element 2, 3 and the reinforcing element 5 ran before the ceramization. In fact, this interface is no longer detectable, and the elements are bonded homogeneously and monolithically to one another by virtue of the ceramization described in FIGS. 2 to 5, such that the composite body 1 is now in one-part form. The composite body has characteristic curves 15 at least between the inner walls 13 or between sides 12 of the cavities 10, but these may also be between the inner walls 13 and the outer walls 14.

FIG. 8 shows the composite body 1 in a perspective schematic diagram. The composite body has a first functional element 2 and a second functional element 3. The reinforcing element 5 is disposed between these functional elements 2, 3. The first functional element 2 and the second functional element 3 are arranged opposite one another here, such that, in particular, the surfaces 4 thereof are parallel to one another. Overall, the composite body 1 has a round, for example a circular, outline. The cavities 10 of the reinforcing element 5 extend through the reinforcing element 5 from the surface 4 of the first functional element 2 to that of the second functional element 3. The base area of the cavities 10 corresponds here to the base area of the former openings 11 prior to the ceramization, where the cavities 10 or the basic shape thereof have a honeycomb structure. By virtue of such a honeycomb structure, the walls 13, 14, especially the inner walls 13, may have a similar thickness and preferably also a uniform thickness.

The inner walls 13 and preferably the outer walls as well additionally have recesses 40, where the recesses 40 are formed such that the cavities 10, by means of the recesses 40, are directly or indirectly bonded fluidically to one another via the inner walls 13 and are connected to an outside environment. Additionally or alternatively, it is of course also possible that the second functional element 3 has recesses 40 via which the cavities 10 are fluidically connected directly to an outside environment. Particularly the working of the green glass body by water jet cutting for production of the cavities 10 makes it possible to establish low wall thicknesses of the inner walls 13. In this way, it is possible to produce a composite body having particularly low weight. Thus, in one embodiment, without restriction to the example shown, the averaged density of the reinforcing element is less than 0.3 g/cm³ or even less than 0.25 g/cm³. The averaged density is found from the ratio of the weight of the reinforcing element to the volume of the reinforcing element defined by the external measurements. In the example, the reinforcing element and the composite element alike have an outside dimension or shell in the form of a flat cylinder. The proportion by volume of the cavities of the reinforcing element, in a further embodiment and without restriction to the example shown in FIG. 8, is at least 85%. It is preferably the case for the composite body, which has a somewhat higher density because of the bulk functional elements, that the averaged density of the composite body is still lower than 0.5 g/cm³. The proportion by volume of the cavities is at least 80% by volume. It is apparent to the person skilled in the art that these embodiments having low density need not be restricted to waterjet-cut elements, since other structuring methods that enable correspondingly thin wall thicknesses of the wall elements may possibly also be used.

The inner walls 13, without restriction to the specific example shown, preferably have the shape of two-dimensional panel-shaped wall elements. For these wall elements, or inner walls 13, the parameter considered for the mechanical stability may be the ratio V=H·B/d² where H is the height, B the width and d the thickness of the inner wall 13. The height here is the dimension between the edges of the inner wall at the openings of the cavities. In the case of a reinforcing element having flat contact faces for the functional elements, the height H thus corresponds to the thickness of the reinforcing element. The width B is measured at right angles thereto and accordingly characterizes the distance between the bonds to adjacent inner walls 13. It is preferable that the ratio V is in a range from 100 to 2500.

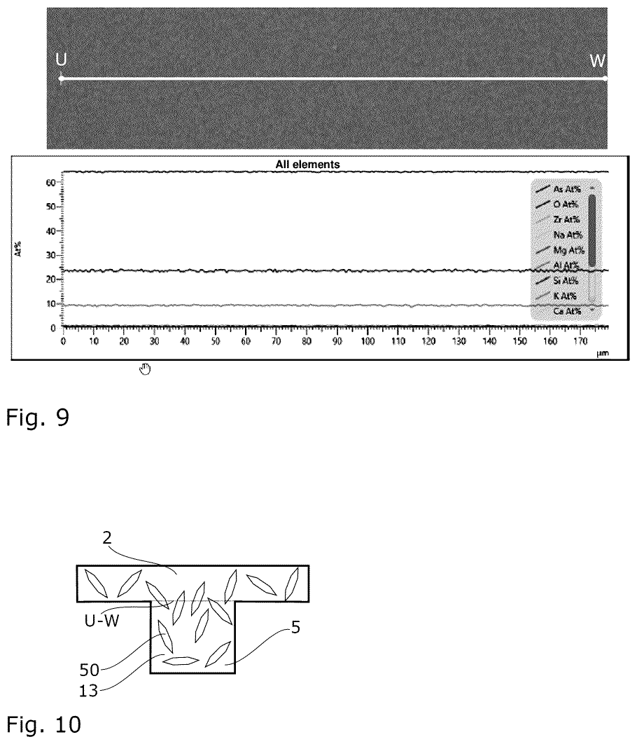

FIG. 9 shows, in the upper part of the figure, a scanning electron micrograph of the connecting region of the functional element 2, 3, which is monolithically bonded to the reinforcing element 5. The image was taken with a NEON40 scanning electron microscope. As shown in FIG. 9, there is visually no apparent interface between two elements, which demonstrates the monolithic character of the bond. Measurement of the chemical composition along the bonding region confirms that the bond of the functional element 2, 3 to the reinforcing element 5 after ceramization or the ceramization method shown in FIGS. 1 to 5 is also chemically homogeneous and monolithic.

The corresponding measurement of the results thereof in the lower part of the diagram shown in FIG. 9 was measured along the path U-W shown as a line on the electron microscope image. The measurement path U-W preferably runs along a surface normal of the surface 4 of the functional element 2, 3 bonded to the reinforcing element 5 and parallel to the inner walls 13 and/or outer walls 14. It is clearly apparent that there are no significant chemical differences along the path U-W, or along the bonding region. This means that, during the ceramization process, the functional element 2, 3 has been bonded to the reinforcing element 5 such that any interface between these elements has completely disappeared.

FIG. 10 shows the bonding region in a schematic cross-sectional view. A functional element 2 is shown here atop, and especially bonded to, the reinforcing element 5. The two elements 2, 5 are cohesively bonded to one another such that crystallites 50 have grown through a bonding surface formed by the two surfaces. This means that the reinforcing element 5 and the functional element 2 are bonded by the crystallites, such that these elements or the material thereof has/have especially fused together or become intermeshed.

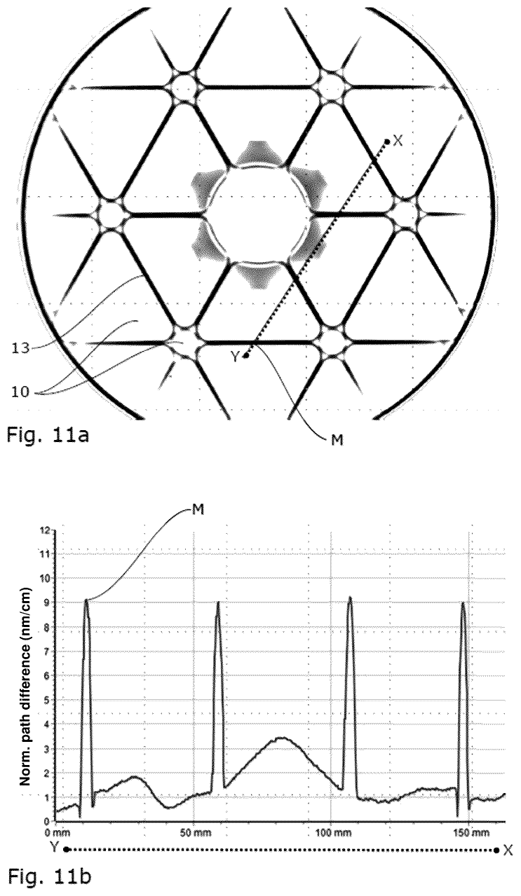

A similar statement can also be made after measurement of the internal stresses of the composite body 1. FIG. 11a is a measurement image of the internal stress distribution of the composite body 1, which has been created by the method of stress birefringence and especially using a high-precision polarimeter from llis. The measurement image (FIG. 11a) shows the structure and shape of the cavities 10 that are between the inner walls 13 of the composite body. The stress was measured on the inner walls 13. The result is the characteristic appearance that shows the outlines of the material regions of the composite body 1 in a front view. It will be apparent that the measurement was made through at least one functional element 2, 3 and the reinforcing element 5, or the glass-ceramic composite body 1 was surveyed in its entirety.

FIG. 11b shows a diagram of the measurement results from a measurement of stress birefringence along the path X-Y shown in FIG. 11a, i.e. a stress measurement at right angles to the connecting plane of the functional element and the reinforcing element. Along the path X-Y, 4 bonding regions were surveyed, which are represented by the respective maxima M of the values. The values that were detected between the inner walls 13, i.e. essentially in the region of the cavities 10, are shown between the maxima M. The values were normalized to the thickness of the composite element, given by the height of the inner walls 13 plus the thickness of the functional element(s). It is found that the measured stresses overall, and hence also in particular in the bonding regions of the functional element 2, 3 and the reinforcing element, are below 12 nm/cm, preferably below 10 nm/cm. In this example, the stress maxima are even only 9 nm/cm, expressed as the normative path difference. In addition, it can be stated that the measured stress birefringence, or the values of the measured stresses, are uniform in multiple bonding regions. Therefore, the measured stress maxima of at least two, preferably a multitude of, bonding regions of a functional element 2, 3 and of a reinforcing element are uniform within a measurement region of 3 nm/cm, preferably 2 nm/cm, more preferably 1 nm/cm. Such values show that, in the course of the process of the invention, stresses were introduced into the material or into the glass-ceramic composite body 1 that are preferably below the usual stresses.

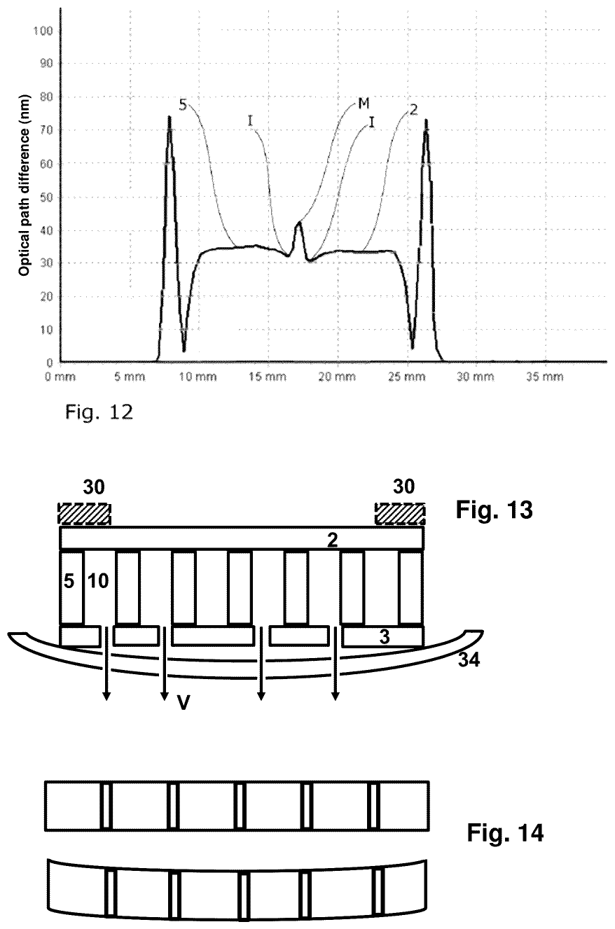

FIG. 12 shows a diagram of the measurement results from a measurement of stress birefringence along a bonding region of the reinforcing element 5 with a functional element 2, 3, where the measurement zone runs parallel to the bonding plane or to the height of the inner walls 13 and at right angles to the surface 4 of the functional element 2. The measurement method is analogous to the measurement shown in FIG. 11b. The diagram shows a clear, but also very low, maximum M of the values between the reinforcing element 5 with a functional element 2, such that, in particular, a or the former interface of these elements prior to ceramization is apparent, or detectable, even after ceramization in a measurement of stress birefringence.

The stress birefringence values measured at this former interface, which is also at right angles to the measurement path U-W in FIG. 9, are in a similar range to the values shown in FIG. 11b. The maximum M of the measured stress at the bonding region is accordingly between 15 nm/cm and 10 nm/cm, expressed as the optical path difference. In a specific type of stress in the bonding region, in or after a measurement of stress birefringence, preferably directly adjoining the maximum, local minima I are also found, which ideally have a path difference below 10 nm, preferably below 8 nm, more preferably below 5 nm, especially with respect to the reinforcing element and/or at least one functional element. The path difference at the maximum M here is higher than in the reinforcing element and/or at least one functional element, and that in the minima I is smaller compared to the reinforcing element and/or at least one functional element.

### LIST OF REFERENCE SYMBOLS

1 glass-ceramic composite body
2 first functional element
3 second functional element
4 surface of the functional element
5 reinforcing element
6 surface of the reinforcing element
10 cavities
11 openings
12 sides of the openings
13 inner walls
14 outer wall
15 curves
15a curve maximum
16 base area of the curves
17 height of the curves
20 base area of the reinforcing element
21 base area of a functional element
30 additional weight
31 base area of the additional weight
32 partial additional weights
33 panel
34 sink shape
40 recesses
50 crystallites
A distance between partial additional weights
P pressure
M maxima in the bonding regions
I minima in the bonding regions
V vacuum

1-14. (canceled)

15. A process for producing a glass-ceramic composite body having a coefficient of thermal expansion CTE in a range from 0 to 50° C. of not more than 0±0.1×10⁻⁶/K, the method comprising:
providing at least two starting elements consisting of a green glass of a glass-ceramic;
arranging the at least two starting elements and contacting surfaces of the starting elements to be bonded;
two-dimensionally pressing the surfaces of the at least two starting elements to be bonded to one another under the action of pressure; and
creating a monolithic bond between the at least two starting elements by heating, under the action of pressure, the at least two starting elements pressed to one another to a temperature Tx at which ceramization of the green glass to the glass-ceramic takes place.

16. The process of claim 15, wherein the surfaces of the at least two starting elements to be bonded are provided with a flatness of less than 300 μm and/or greater than 20 μm.

17. The process of claim 15, further comprising the step of controlled geometric deformation of at least one of the at least two starting elements at a temperature between T_{g} and T_{g}+Tₛ by sagging into a target shape.

18. The process of claim 15, further comprising the step of processing at least one of the at least two starting elements by water-jet cutting, CNC processing and/or sandblasting.

19. The process of claim 15, wherein at least one of the at least two starting elements has a surface interrupted by cavities and/or at least one of the at least two starting elements has a plate- or disk-shaped form.

20. The process of claim 15, wherein the pressure is generated by at least one added weight in a two-dimensional arrangement on or above at least one of the at least two starting elements and/or wherein the pressure is generated by a vacuum on the green glass structure.

21. The process of claim 15, wherein at least one of the at least two starting elements has a diameter and/or an edge length of at least 400 mm.

22. A monolithic composite body which has a coefficient of thermal expansion CTE in the range from 0 to 50° C. of not more than 0±0.1×10⁻⁶/K, and which is produced by the process of claim 1.

23. The composite body of claim 22, having a diameter or an edge length of at least 400 mm.

24. The composite body of claim 22, wherein at least one of the at least two starting elements is a reinforcing element and/or at least one of the at least two starting elements is a functional element.

25. The composite body of claim 24, wherein mechanical stresses in a bonding region of the surface of the reinforcing element and the surface of the functional element are configured such that a stress of less than 20 nm/cm is measurable by stress birefringence measurement.

26. The composite body of claim 24, wherein at least one of the following is satisfied:
an averaged density of the reinforcing element is less than 0.3 g/cm³;
an averaged density of the composite body is less than 0.5 g/cm³; or
a ratio V=H·B/d² is in a range from 100 to 2500, wherein H denotes a height of the reinforcing element, B denotes a width of the reinforcing element, and d denotes a thickness of inner walls of the reinforcing element.

27. The composite body of claim 22, wherein the surface of one of the at least two starting elements is cohesively bonded to the surface of at least one other one of the at least two starting elements such that crystallites have grown through a bonding surface formed by the two surfaces and penetrate both surfaces.

28. The composite body of claim 22, wherein the composite body is a lightweight mirror.
